(19) United States
(12) Patent Application Publication
(10) Pub. No.: US 2024/0394867 A1
(43) Pub. Date: Nov. 28, 2024

(54) METHOD FOR CHARACTERIZING A NETWORK TO BE ANALYSED COMPRISING PERIODIC PATTERNS

(71) Applicant: COMMISSARIAT A L'ENERGIE ATOMIQUE ET AUX ENERGIES ALTERNATIVES, Paris (FR)

(72) Inventor: Lucas JALOUSTRE, Grenoble (FR)

(73) Assignee: COMMISSARIAT A L'ENERGIE ATOMIQUE ET AUX ENERGIES ALTERNATIVES, Paris (FR)

(21) Appl. No.: 18/694,084

(22) PCT Filed: Sep. 20, 2022
(86) PCT No.: PCT/EP2022/076129

§ 371 Date: Mar. 21, 2024

(30) Foreign Application Priority Data
Sep. 23, 2021 (FR) 2110021

(51) Int. Cl. G06T 7/00; G01N 23/2251; G06T 7/62

(52) U.S. Cl. CPC G06T 7/001; G01N 23/2251; G06T 7/62; G01N 2223/401; G01N 2223/6116; G06T 2207/10061; G06T 2207/20072

(57) ABSTRACT

A method for characterizing a network to be analyzed comprising periodic patterns, the method including providing a digital image of a reference network, showing a reference series of periodic patterns; defining a reference pattern based on the patterns of the reference series; providing first and second digital images of the network to be analyzed, the images being generated by a scanning electron microscope and showing first and second series of periodic patterns, respectively, the first and second digital images being obtained from backscattered electrons and from secondary electrons, respectively; computing a correlation coefficient between each pattern of the first and second series and the reference pattern; and extracting a characteristic dimension for each pattern of the first and second series the correlation coefficient of which, in absolute value, is greater than a predetermined threshold.

### TECHNICAL FIELD

The invention relates to the technical field of characterization (dimensional analysis) of a network of periodic patterns through image processing.

The invention is in particular applicable when the periodic patterns are nanostructures, such as nanowires formed by epitaxy.

### PRIOR ART

Defects in nanostructures, such as nanowires or nanopyramids for example, may be related to their epitaxial growth on a substrate (e.g. a wafer), or to other technological steps applied thereto, and that in particular lead to non-uniformities in size when it is a question of nanowires. Those skilled in the art are required to identify nanostructures with morphological defects (defects in size or geometry), and to obtain quantitative feedback on the quality of the epitaxy in order to determine whether the nanowires of the substrate are of a sufficient quality to undergo additional technological steps of an industrial process in production mode.

A defect-detecting method known in the prior art, and in particular from document U.S. Pat. No. 9,311,698 B2, detects defects based on a correlation with a reference feature.

Such a prior-art method, the approach of which is based on a threshold, is not entirely satisfactory for detecting defects in nanostructures. Nanostructures exhibit dispersion, in particular in size, shape, contrast and brightness, this making it extremely complex to accurately determine a threshold allowing reliable detection of defects. In particular, such a prior art method is liable to erroneously consider nanostructures to be free of defects, or to erroneously consider nanostructures to contain defects.

### SUMMARY OF THE INVENTION

The invention aims to completely or partially remedy the aforementioned drawbacks. To this end, one subject of the invention is a method for characterizing a network to be analyzed comprising periodic patterns, the method comprising steps of:
a) providing a digital image of a reference network, showing a reference series of periodic patterns;
b) defining a reference pattern based on the patterns of the reference series;
c) providing first and second digital images of the network to be analyzed, said images being generated by a scanning electron microscope and showing first and second series of periodic patterns, respectively, the first and second digital images being obtained from backscattered electrons and from secondary electrons, respectively;
d) computing a correlation coefficient between each pattern of the first and second series and the reference pattern;
e) extracting a characteristic dimension for each pattern of the first and second series the correlation coefficient of which, in absolute value, is greater than a predetermined threshold.

### Definitions

By “periodic patterns”, what is meant is patterns spaced apart by a regular distance interval (spatial period). In a perfect network, the periodic patterns are identical replicas. In practice, the expression “identical” is understood to mean within the usual tolerances related to the experimental conditions of manufacture, and not in the literal sense of the term.
The term “provide” means to use.
By “reference network”, what is meant is a network the periodic patterns of which have geometrical characteristics that are known beforehand (e.g. through measurements), and that meet given industrial specifications.
By “reference pattern”, what is meant is a pattern which has geometrical characteristics that are known beforehand (e.g. through measurements) and that meet given industrial specifications.
By “backscattered electrons”, what is meant is electrons of the incident beam of the scanning electron microscope that have collided (elastic or quasi-elastic collision) with the atoms of the network to be analyzed.
By “secondary electrons”, what is meant is electrons emitted by the atoms of the network to be analyzed (ionization process), following inelastic interaction with the incident beam.
By “characteristic dimension”, what is meant is a specific dimension (spatial extent) allowing a distinction to be drawn between the patterns of the first series (and between the patterns of the second series) each correlation coefficient of which, in absolute value, is greater than the predetermined threshold.

Thus, such a method according to the invention makes it possible to perform, by virtue of steps c) to e), a double dimensional analysis of the network that is more reliable and robust than in the prior art. Specifically, the first digital image benefits from a high contrast when material composition within the network changes, this contrast being related to the properties of the backscattered electrons (which are sensitive to atomic number). Exploiting this high contrast, characteristic dimensions may thus be accurately extracted for the patterns of the first series. The second digital image benefits from a high contrast when there is a variation in surface topography within the network, this contrast being related to the properties of the secondary electrons (low kinetic energy, as they are emitted by external atomic layers). Exploiting this high contrast, characteristic dimensions may thus be accurately extracted for the patterns of the second series.

Such a method according to the invention therefore makes it possible to greatly limit detection errors that lead to nanostructures being erroneously considered not to contain defects related to non-uniformities in size. This double dimensional analysis allows the nature of the detected defects to be discerned, and makes it easier to determine the origin of these defects, for example by distinguishing between the influence of the epitaxy and the influence of other technological steps in the case of a network of epitaxially grown nanowires, with a view to improving the uniformity and reproducibility of the periodic patterns.

Another subject of the invention is method for characterizing a set of networks to be analyzed each comprising periodic patterns, the method comprising steps of:
a) providing a digital image of a reference network, showing a reference series of periodic patterns;
b) defining a reference pattern based on the patterns of the reference series;
c) providing:
   at least a first digital image of each network to be analyzed of the set, said image being generated by a scanning electron microscope, obtained from backscattered electrons, and showing a first series of periodic patterns,
   at least a second digital image of each network to be analyzed of the set, said image being generated by a scanning electron microscope, obtained from secondary electrons, and showing a second series of periodic patterns,
the method iterating the following steps, for each first digital image and each second digital image of each network to be analyzed of the set:
d) computing a correlation coefficient between each pattern of the first and second series and the reference pattern;
e) extracting a characteristic dimension for each pattern of the first and second series the correlation coefficient of which, in absolute value, is greater than a predetermined threshold.

Thus, such a method according to the invention has the same advantages as those mentioned above. An additional advantage is to be able to iterate the double dimensional analysis for each network of the set before undertaking additional technological steps of an industrial process in production mode.

The process according to the invention may comprise one or more of the following features.

According to one feature of the invention, step e) comprises steps of:
e₁) cutting a sectional line for each pattern of the first and second series the correlation coefficient of which, in absolute value, is greater than the predetermined threshold;
e₂) extracting the characteristic dimension from the sectional line.

Thus, one advantage obtained is to be able to easily measure the characteristic dimension based on an image-processing operation.

According to one feature of the invention, the network to be analyzed comprises nanowires, which form periodic patterns, and which each have:
a height;
a circular transverse cross section possessing a diameter.

### Definition

By “transverse”, what is meant is a cross section that intersects the longitudinal axis of the nanowires perpendicularly. The longitudinal axis is the axis extending along the height of the nanowires.

According to one feature of the invention, step e) consists in extracting:
first and second characteristic dimensions, for each pattern of the first series the correlation coefficient of which, in absolute value, is greater than the predetermined threshold;
first and second characteristic dimensions, for each pattern of the second series the correlation coefficient of which, in absolute value, is greater than the predetermined threshold,
the first characteristic dimensions extracted for each pattern of the first and second series being representative of the height, the second characteristic dimensions extracted for each pattern of the first and second series being representative of the diameter.

Thus, one advantage obtained is that the contrasts of the first and second digital images are combined to accurately measure height based on the first characteristic dimensions extracted for each pattern of the first and second series. Similarly, one advantage obtained is that the contrasts of the first and second digital images are combined to accurately measure diameter based on the second characteristic dimensions extracted for each pattern of the first and second series.

According to one feature of the invention, step c) comprises a step c₁) of acquiring the first and second digital images so as to:
show in perspective the patterns of the first and second series;
observe a space between the patterns of the first series, and a space between the patterns of the second series.

In other words, step c) comprises a step c₁) of acquiring the first and second digital images so that the acquired first and second digital images:
show in perspective the patterns of the first and second series;
observe a space between the patterns of the first series, and a space between the patterns of the second series.

Thus, one advantage obtained is to improve the reliability of the extraction of the characteristic dimensions.

According to one feature of the invention, step c₁) comprises a step of providing a carrier having a planar surface intended to receive the network to be analyzed, the planar surface being defined by first and second directions, the carrier being rotatable about a vertical axis and about the first and second directions.

In other words, the planar surface lies in a plane defined by first and second perpendicular directions.

By “vertical axis”, what is meant is an axis of rotation extending in a direction parallel to the direction of gravity as in particular given by a plumb line. The vertical axis of rotation is defined in absolute terms, i.e. it is not a direction perpendicular to the first and second directions, except when the carrier is horizontal. The scanning electron microscope has an optical axis. The carrier is rotatable about the vertical axis of rotation coincident with the optical axis of the scanning electron microscope.

Thus, one advantage obtained is to be able to control the position of the patterns of the network to be analyzed with respect to the position of the means for acquiring the first and second digital images, so that the first and second digital images may:
(i) show in perspective the patterns of the first and second series;
(ii) observe a space between the patterns of the first series, and a space between the patterns of the second series.

According to one feature of the invention, step e) comprises steps of:
e′₁) cutting:
   a first sectional line, along the vertical axis, for each pattern of the first and second series the correlation coefficient of which, in absolute value, is greater than the predetermined threshold;
   a second sectional line, along the first direction or second direction, for each pattern of the first and second series the correlation coefficient of which, in absolute value, is greater than the predetermined threshold;
e′₂) extracting:
   a first characteristic dimension from the first sectional line;
   a second characteristic dimension from the second sectional line.

In other words, step e) comprises the steps:
e′₁) cutting:
   a first sectional line, along a vertical axis of the first and second digital images, for each pattern of the first and second series the correlation coefficient of which, in absolute value, is greater than the predetermined threshold;
   a second sectional line, along the first direction or second direction, for each pattern of the first and second series the correlation coefficient of which, in absolute value, is greater than the predetermined threshold;
e′₂) extracting:
   a first characteristic dimension from the first sectional line;
   a second characteristic dimension from the second sectional line.

The first sectional line is cut along a vertical axis of the first and second digital images. The vertical axis of the first and second digital images in particular depends on the inclination of the carrier with respect to the vertical axis of rotation of the carrier. The optical axis of the scanning electron microscope coincides with the vertical axis of rotation of the carrier.

Thus, when the network to be analyzed comprises nanowires, one advantage obtained is that the contrasts of the first and second digital images are combined to accurately measure the height of the nanowires based on the first sectional lines. Similarly, one advantage obtained is that the contrasts of the first and second digital images are combined to accurately measure the diameter of the nanowires based on the second sectional lines.

According to one feature of the invention, step b) consists in selecting a pattern among the patterns of the reference series, the selected pattern defining the reference pattern.

Thus, one advantage obtained is to permit manual selection of the reference pattern.

According to one feature of the invention, step b) comprises the steps:
b₁) selecting an initial pattern among the patterns of the reference series;
b₂) computing a correlation coefficient between each pattern of the reference series and the initial pattern;
b₃) identifying the patterns of the reference series the correlation coefficients of which, in absolute value, are greater than a predetermined threshold;
b₄) defining the reference pattern based on a combination of the patterns of the reference series identified in step b₃).

Thus, one advantage obtained is to improve the reliability and representativeness of the reference pattern.

According to one feature of the invention, the reference pattern is defined in step b) by taking an average of the patterns of the reference series.

Thus, one advantage obtained is to improve the reliability and representativeness of the reference pattern, when the digital image of the reference network is of good quality (low defect rate). The term “average” is understood to mean an average of the intensities of the pixels of the patterns of the reference series.

According to one feature of the invention, the digital image of the reference network provided in step a) and the first and second digital images of the network to be analyzed provided in step c) each comprise a set of pixels, each pixel possessing an intensity; and the correlation coefficient is computed in step d) between the intensity of the pixels of each pattern of the first and second series and the intensity of the pixels of the reference pattern.

According to one feature of the invention, the correlation coefficient computed in step d) is the Pearson correlation coefficient.

According to one feature of the invention:
step d) is followed by a step d′) consisting in counting a total number of patterns of the first and second series the correlation coefficient of which, in absolute value, is greater than the predetermined threshold;
step e) is executed if the total number of patterns is greater than a predetermined value.

In other words:
step d) is followed by a step d′) consisting in counting a total number of patterns of the first and second series the correlation coefficient of which, in absolute value, is greater than the predetermined threshold, step d) being executed before step e);
step e) is executed if the total number of patterns is greater than a predetermined value.

Thus, one advantage obtained is to guarantee a minimum number of patterns to be analyzed in step e), so as to obtain a dimensional analysis that is reliable and representative from a statistical point of view.

According to one feature of the invention, the method comprises a step f) of generating a histogram of the characteristic dimensions extracted in step e).

### BRIEF DESCRIPTION OF THE DRAWINGS

Other features and advantages will become apparent from the detailed description of various embodiments of the invention, the description containing examples and references to the appended drawings.

FIG. 1 is a flowchart schematically showing one method according to the invention.

FIG. 2 is a flowchart schematically showing one method according to the invention, and in particular illustrating iteration of steps d) and e) in the case of a set of networks to be analyzed.

FIG. 3 is a flowchart schematically showing one method according to the invention, and in particular illustrating steps e₁) and e₂).

FIG. 4 is a flowchart schematically showing one method according to the invention, and in particular illustrating step c₁).

FIG. 5 is a flowchart schematically showing one method according to the invention, and in particular illustrating steps e′₁) and e′₂).

FIG. 6 is a flowchart schematically showing one method according to the invention, and in particular illustrating steps b₁) to b₄).

FIG. 7 is a flowchart schematically showing one method according to the invention, and in particular illustrating step d′).

FIG. 8 is a flowchart schematically showing one method according to the invention, and in particular illustrating step f).

FIG. 9 is a schematic top view illustrating (on the left), partially, patterns of a network to be analyzed, and illustrating (on the right) the position of a carrier intended to receive the network to be analyzed.

FIG. 10 is a schematic perspective view illustrating (on the left), partially, patterns of a network to be analyzed, and illustrating (on the right) the position of a carrier intended to receive the network to be analyzed, the carrier having undergone a rotation about a horizontal axis with respect to FIG. 9.

FIG. 11 is a schematic perspective view illustrating (on the left), partially, patterns of a network to be analyzed, and illustrating (on the right) the position of a carrier intended to receive the network to be analyzed, the carrier having undergone a rotation about a vertical axis with respect to FIG. 10.

FIG. 12 is a schematic perspective view illustrating (on the left) a nanowire present in an image obtained from backscattered electrons, and illustrating (on the right) a vertical sectional line.

FIG. 13 is a schematic perspective view illustrating (on the left) a nanowire present in an image obtained from secondary electrons, and illustrating (on the right) a vertical sectional line.

FIG. 14 is a schematic perspective view illustrating (on the left) a nanowire, possessing what is referred to as a collar morphology, present in an image obtained from backscattered electrons, and illustrating (on the right) a vertical sectional line.

FIG. 15 is a schematic perspective view illustrating (on the left) a nanowire, possessing what is referred to as a collar morphology, present in an image obtained from secondary electrons, and illustrating (on the right) a vertical sectional line.

The shapes used in FIGS. 1 to 8 comply with the flowchart conventions of standard ISO 5807. “Y” means “Yes”, i.e. the test result is true. “N” means “No”, i.e. the test result is false.

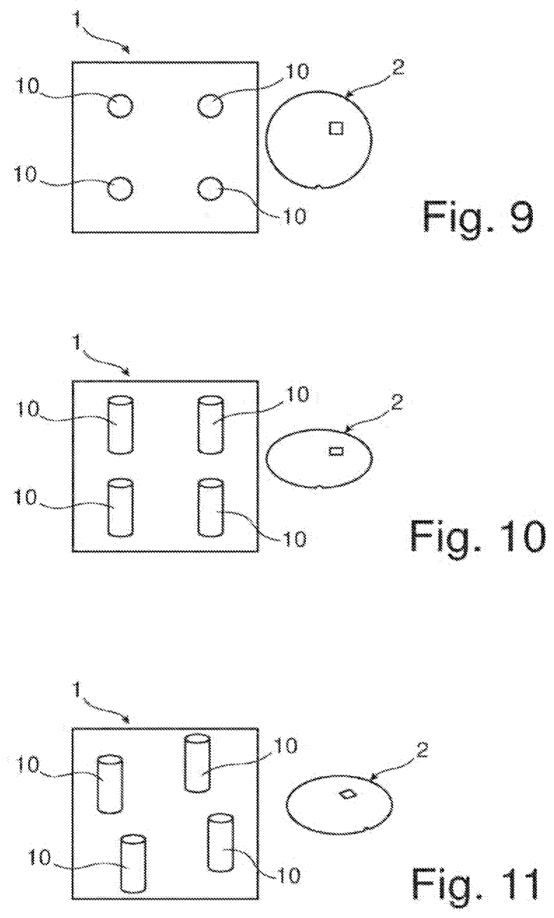

It will be noted that FIGS. 9 to 15 described above are schematic, and have not necessarily been drawn to scale for the sake of legibility and to simplify comprehension thereof.

### DETAILED DESCRIPTION OF EMBODIMENTS

For the sake of simplicity, elements that are identical or that perform the same function in the various embodiments have been designated with the same references.

### A Network to be Analyzed

As illustrated in FIG. 1, one subject of the invention is method for characterizing a network to be analyzed 1 comprising periodic patterns 10, the method comprising steps of:
a) providing a digital image of a reference network, showing a reference series of periodic patterns;
b) defining a reference pattern based on the patterns of the reference series;
c) providing first and second digital images of the network to be analyzed 1, said images being generated by a scanning electron microscope and showing first and second series of periodic patterns 10, respectively, the first and second digital images being obtained from backscattered electrons and from secondary electrons, respectively;
d) computing a correlation coefficient between each pattern 10 of the first and second series and the reference pattern;
e) extracting a characteristic dimension for each pattern 10 of the first and second series the correlation coefficient of which, in absolute value, is greater than a predetermined threshold.

### Step a)

The digital image of the reference network, provided in step a), comprises a set of pixels, each pixel possessing an intensity. By way of non-limiting example, the digital image of the reference network, provided in step a), may have a TIFF format (TIFF standing for Tag Image File Format). The digital image of the reference network may be a grayscale image.

### Step b)

Step b) may consist in selecting a pattern from among the patterns of the reference series, the selected pattern defining the reference pattern. The reference pattern may be selected by a user via a graphical user interface (GUI) possessing a selection window, which is for example square. The selection window may have a cropping function.

As illustrated in FIG. 6, step b) may comprise the steps:
b₁) selecting an initial pattern among the patterns of the reference series;
b₂) computing a correlation coefficient between each pattern of the reference series and the initial pattern;
b₃) identifying the patterns of the reference series the correlation coefficients of which, in absolute value, are greater than a predetermined threshold;
b₄) defining the reference pattern based on a combination of the patterns of the reference series identified in step b₃).

Step b₁) is implemented by the user but steps b₂) to b₄) are advantageously implemented by a computer. The initial pattern selected in step b₁) by the user must be representative of a reference pattern. The patterns in the reference series, identified in step b₃), may represent between 0.5% and 1% of the total number of patterns in the reference series.

According to one alternative, the reference pattern is defined in step b) by taking an average of the patterns of the reference series.

According to another alternative, it is possible to provide, in step a), a plurality of digital images of reference networks, each showing one reference series of periodic patterns. Step b) may then consist in defining the reference pattern based on an average of the intensities of the pixels of the reference series of periodic patterns of the digital images of reference networks.

### Step c)

The first and second digital images of the network to be analyzed 1, provided in step c), each comprise a set of pixels, each pixel possessing an intensity. By way of non-limiting example, the first and second digital images of the network to be analyzed 1, provided in step c), may have a TIFF format (TIFF standing for Tag Image File Format). The first and second digital images of the network to be analyzed 1 may be grayscale images.

The network to be analyzed 1 may comprise nanowires, forming periodic patterns 10, and each having:
a height;
a circular transverse cross section possessing a diameter.

As illustrated in FIG. 4, step c) advantageously comprises a step c₁) of acquiring the first and second digital images so as to:
show in perspective the patterns 10 of the first and second series;
observe a space between the patterns 10 of the first series, and a space between the patterns 10 of the second series.

Step c₁) is advantageously implemented by a computer.

As illustrated in FIGS. 9 to 11, step c₁) advantageously comprises a step of providing a carrier 2 having a planar surface intended to receive the network to be analyzed 1, the planar surface being defined by first and second directions, the carrier 2 being rotatable about a vertical axis and about the first and second directions.

### Step d)

Step d) is advantageously implemented by a computer.

The correlation coefficient is advantageously computed in step d) between the intensity of the pixels of each pattern 10 of the first and second series and the intensity of the pixels of the reference pattern. Advantageously, the correlation coefficient computed in step d) is the Pearson correlation coefficient, which is known to those skilled in the art.

More precisely, the correlation between the reference pattern and each point of the digital image of the network to be analyzed 1 (first or second digital image) is computed via an image correlation function. This image correlation function will compare the reference pattern, T (xₜ, yₜ), where (xₜ, yₜ) are the coordinates of each pixel of the reference pattern, with the image of the network to be analyzed 1, S(x, y), where (x, y) are the coordinates of each pixel of the image of the network to be analyzed 1. The image correlation function consists in computing the sum of the products of the coefficients of S (x, y) and T (xₜ, yₜ) for all the positions of the reference pattern with respect to the image of the network to be analyzed 1. It is then possible to renormalize the sum of the products of the coefficients of S (x, y) and T (xₜ, yₜ) to obtain a result between −1 and 1. “−1” indicates anti-correlation, “0” indicates no correlation, and “1” indicates perfect correlation. This correlation coefficient corresponds to a linear Pearson correlation coefficient, denoted r, between two real random variables X and Y. The linear Pearson correlation coefficient is generally described by the following relationship:

$$r = \frac{Cov ( X , Y )}{{σ}_{X} {σ}_{Y}}$$

where:
   Cov (X,Y) designates the covariance of the variables X and Y;
   σ_{X} and σ_{Y} designate the standard deviation of variable X and the standard deviation of variable Y, respectively;
   X and Y correspond to the matrix of the intensities of the pixels of the image of the network to be analyzed 1 (first or second digital image), and to the matrix of the intensities of the pixels of the reference pattern, respectively.

As illustrated in FIG. 7, step d) is advantageously followed by a step d′) consisting in counting a total number of patterns 10 of the first and second series the correlation coefficient of which, in absolute value, is greater than the predetermined threshold. Step d′) is advantageously implemented by a computer. Step e) is executed if the total number of patterns 10 is greater than a predetermined value. The conditional branch (symbolized by a diamond) of FIG. 7 tests whether the total number of patterns 10 is greater than said predetermined value.

### Step e)

Step e) is advantageously implemented by a computer.

By way of non-limiting example, the threshold may be between 0.6 and 0.7.

As illustrated in FIG. 3, step e) advantageously comprises the steps:
e₁) cutting a sectional line for each pattern 10 of the first and second series the correlation coefficient of which, in absolute value, is greater than the predetermined threshold;

e₂) extracting the characteristic dimension from the sectional line.

According to one mode of implementation, step e) consists in extracting:
first and second characteristic dimensions, for each pattern 10 of the first series the correlation coefficient of which, in absolute value, is greater than the predetermined threshold;
first and second characteristic dimensions, for each pattern 10 of the second series the correlation coefficient of which, in absolute value, is greater than the predetermined threshold,
the first characteristic dimensions extracted for each pattern 10 of the first and second series being representative of the height,
the second characteristic dimensions extracted for each pattern 10 of the first and second series being representative of the diameter.

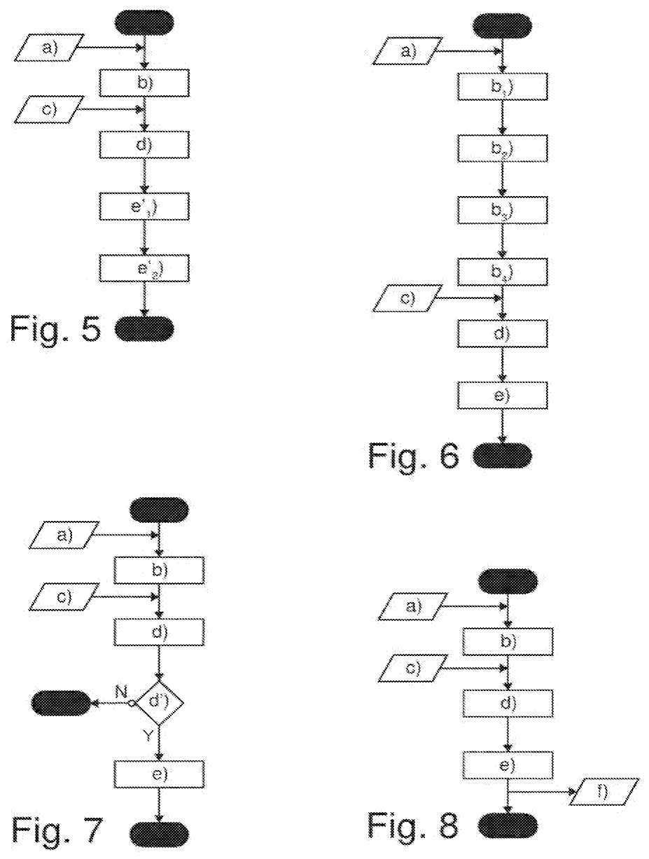

According to one mode of implementation illustrated in FIG. 5, step e) comprises the steps:
e′₁) cutting:
   a first sectional line, along the vertical axis, for each pattern 10 of the first and second series the correlation coefficient of which, in absolute value, is greater than the predetermined threshold;
   a second sectional line, along the first direction or second direction, for each pattern 10 of the first and second series the correlation coefficient of which, in absolute value, is greater than the predetermined threshold;
e′₂) extracting:
   a first characteristic dimension from the first sectional line;
   a second characteristic dimension from the second sectional line.

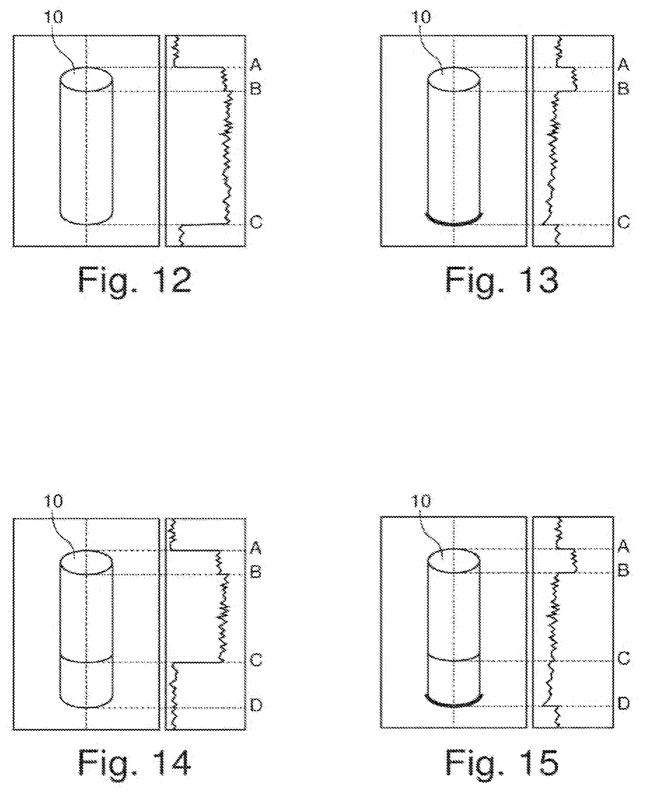

As illustrated in FIG. 12, the first sectional line cut in step e′1) for each pattern 10 of the first series makes it possible to clearly identify the start and the end of the pattern 10 (points A and C), when the pattern 10 is a nanowire. As illustrated in FIG. 13, the first sectional line cut in step e′1) for each pattern 10 of the second series makes it possible to clearly identify the top of the pattern 10 (point B), when the pattern 10 is a nanowire. The height of the nanowire corresponds to the distance between points B and C.

As illustrated in FIG. 14, the first sectional line cut in step e′1) for each pattern 10 of the first series makes it possible to clearly identify the interface between the nanowire and the collar (point C), when the pattern 10 is a nanowire possessing what is referred to as a collar morphology, and the start and end of the nanowire (points C and A). As shown in FIG. 15, the first sectional line cut in step e′1) for each pattern 10 of the second series makes it possible to clearly identify the top of the pattern 10 (point B) and the start of the collar (point D), when the pattern 10 is a nanowire possessing what is referred to as a collar morphology. The height of the nanowire corresponds to the distance between points B and C. The height of the collar corresponds to the distance between points C and D.

The measurement of the height of the nanowire (or of the collar) takes into account the angle of rotation of the carrier 2 about the first and second directions. Generally, the characteristic dimensions extracted in step e) are initially determined in pixels and then converted into μm using the size of the pixels.

### Step f)

As illustrated in FIG. 8, the method advantageously comprises a step f) of generating a histogram of the characteristic dimensions extracted in step e). Step f) is advantageously implemented by a computer.

### A Set of Networks to be Analyzed

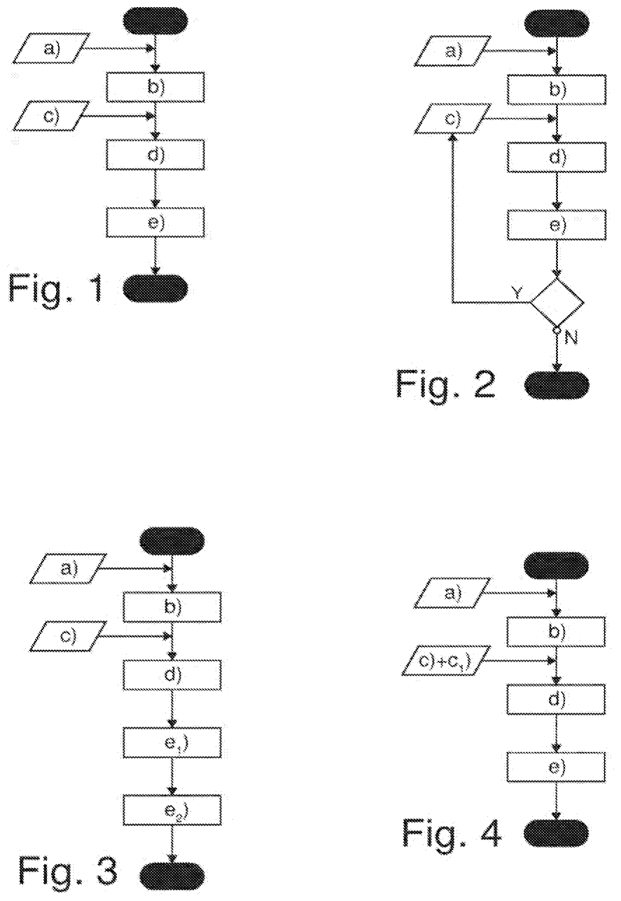

As illustrated in FIG. 2, one subject of the invention is method for characterizing a set of networks to be analyzed 1 each comprising periodic patterns 10, the method comprising steps of:
a) providing a digital image of a reference network, showing a reference series of periodic patterns;
b) defining a reference pattern based on the patterns of the reference series;
c) providing:
   at least a first digital image of each network to be analyzed 1 of the set, said image being generated by a scanning electron microscope, obtained from backscattered electrons, and showing a first series of periodic patterns 10,
   at least a second digital image of each network to be analyzed 1 of the set, said image being generated by a scanning electron microscope, obtained from secondary electrons, and showing a second series of periodic patterns 10,
   the method iterating the following steps, for each first digital image and each second digital image of each network to be analyzed 1 of the set:
d) computing a correlation coefficient between each pattern 10 of the first and second series and the reference pattern;
e) extracting a characteristic dimension for each pattern 10 of the first and second series the correlation coefficient of which, in absolute value, is greater than a predetermined threshold.

The technical features described above in respect of steps a) to e) apply to this subject of the invention. The conditional branch (symbolized by a diamond) in FIG. 2 tests the presence of a first or second digital image of a network to be analyzed 1.

The invention is not limited to the disclosed embodiments. Anyone skilled in the art will be able to consider technically workable combinations thereof, and to substitute equivalents therefor.

1. A method for characterizing a network to be analyzed comprising periodic patterns, the method comprising:
a) providing a digital image of a reference network, showing a reference series of periodic patterns;
b) defining a reference pattern based on the patterns of the reference series;
c) providing first and second digital images of the network to be analyzed, said images being generated by a scanning electron microscope and showing first and second series of periodic patterns, respectively, the first and second digital images being obtained from backscattered electrons and from secondary electrons, respectively;
d) computing a correlation coefficient between each pattern of the first and second series and the reference pattern; and
e) extracting a characteristic dimension for each pattern of the first and second series the correlation coefficient of which, in absolute value, is greater than a predetermined threshold.

2. A method for characterizing a set of networks to be analyzed, each comprising periodic patterns, the method comprising:
a) providing a digital image of a reference network, showing a reference series of periodic patterns;
b) defining a reference pattern based on the patterns of the reference series; and
c) providing:
at least a first digital image of each network to be analyzed of the set, said image being generated by a scanning electron microscope, obtained from backscattered electrons, and showing a first series of periodic patterns, and
at least a second digital image of each network to be analyzed of the set, said image being generated by a scanning electron microscope, obtained from secondary electrons, and showing a second series of periodic patterns,
the method further iterating the following steps, for each first digital image and each second digital image of each network to be analyzed of the set:
d) computing a correlation coefficient between each pattern of the first and second series and the reference pattern; and
e) extracting a characteristic dimension for each pattern of the first and second series the correlation coefficient of which, in absolute value, is greater than a predetermined threshold.

3. The method as claimed in claim 1, wherein the step e) further comprises:
e₁) cutting a sectional line for each pattern of the first and second series, the correlation coefficient of which, in absolute value, is greater than the predetermined threshold; and
e₂) extracting the characteristic dimension from the sectional line.

4. The method as claimed in claim 1, wherein the network to be analyzed comprises nanowires, which form periodic patterns, and which each have a height, and a circular transverse cross section possessing a diameter.

5. The method as claimed in claim 4, wherein the step e) further comprises extracting:
first and second characteristic dimensions, for each pattern of the first series the correlation coefficient of which, in absolute value, is greater than the predetermined threshold; and
first and second characteristic dimensions, for each pattern of the second series the correlation coefficient of which, in absolute value, is greater than the predetermined threshold, wherein
the first characteristic dimensions extracted for each pattern of the first and second series are representative of the height, and
the second characteristic dimensions extracted for each pattern of the first and second series are representative of the diameter.

6. The method as claimed in claim 1, wherein the step c) comprises c₁) acquiring the first and second digital images so as to:
show in perspective the patterns of the first and second series; and
observe a space between the patterns of the first series, and a space between the patterns of the second series.

7. The method as claimed in claim 6, wherein the step c₁) further comprises providing a carrier having a planar surface to receive the network to be analyzed, the planar surface being defined by first and second directions, the carrier being rotatable about a vertical axis and about the first and second directions.

8. The method as claimed in claim 7, wherein the step e) further comprises:
e′₁) cutting:
a first sectional line, along the vertical axis, for each pattern of the first and second series the correlation coefficient of which, in absolute value, is greater than the predetermined threshold; and
a second sectional line, along the first direction or second direction, for each pattern of the first and second series the correlation coefficient of which, in absolute value, is greater than the predetermined threshold; and
e′₂) extracting:
a first characteristic dimension from the first sectional line; and
a second characteristic dimension from the second sectional line.

9. The method as claimed in claim 1, wherein the step b) further comprises selecting a pattern among the patterns of the reference series, the selected pattern defining the reference pattern.

10. The method as claimed in claim 1, wherein the step b) further comprises:
b₁) selecting an initial pattern among the patterns of the reference series;
b₂) computing a correlation coefficient between each pattern of the reference series and the initial pattern;
b₃) identifying the patterns of the reference series the correlation coefficients of which, in absolute value, are greater than a predetermined threshold; and
b₄) defining the reference pattern based on a combination of the patterns of the reference series identified in step b₃).

11. The method as claimed in claim 1, wherein the reference pattern is defined in the step b) by taking an average of the patterns of the reference series.

12. The method as claimed in claim 1, wherein the digital image of the reference network provided in the step a) and the first and second digital images of the network to be analyzed provided in the step c) each comprise a set of pixels, each pixel possessing an intensity; and
the correlation coefficient is computed in the step d) between the intensity of the pixels of each pattern of the first and second series and the intensity of the pixels of the reference pattern.

13. The method as claimed in claim 1, wherein the correlation coefficient computed in the step d) is the Pearson correlation coefficient.

14. The method as claimed in claim 1, wherein:
the step d) is followed by a step d′) including counting a total number of patterns of the first and second series the correlation coefficient of which, in absolute value, is greater than the predetermined threshold; and
the step e) is executed if the total number of patterns is greater than a predetermined value.

15. The method as claimed in claim 1, further comprising a step f) of generating a histogram of the characteristic dimensions extracted in the step e).
